(19) United States
(12) Patent Application Publication
(10) Pub. No.: US 2026/0007931 A1
(43) Pub. Date: Jan. 8, 2026

(54) QUICKDRAW CONNECTOR, QUICKDRAW AND MANUFACTURING METHOD

(71) Applicant: ZEDEL, Crolles (FR)

(72) Inventor: Loïc BLONDEAU, La Tronche (FR)

(73) Assignee: ZEDEL, Crolles (FR)

(21) Appl. No.: 19/219,725

(22) Filed: May 27, 2025

(30) Foreign Application Priority Data
Jul. 4, 2024 (FR) 2407302

(51) Int. Cl. A63B 29/02

(52) U.S. Cl. CPC A63B 29/02

(57) ABSTRACT

A quickdraw connector comprises a coil of a wire element. A first tubular element surrounds the coil and extends in a longitudinal direction of the wire element. An additional tubular element is arranged around the coil to form an additional sheath. The coil is salient from the two opposite ends of the additional tubular element to define a first ring and a second ring designed to receive a carabiner. The second ring is separated from the first ring by the additional sheath. The first sheath continuously surrounds the coil along the first ring and the second ring to define a sheath of first ring and a sheath of second ring. A quickdraw comprises such quickdraw connector.

### BACKGROUND OF THE INVENTION

The invention relates to a quickdraw connector, to a quickdraw and to a method for manufacturing one such quickdraw connector.

### STATE OF THE ART

In mountaineering and in other mountain activities, it is common practice to use quickdraws that are attached to an anchor point and are designed to receive a rope. The quickdraw has two carabiners that are connected by a flexible connector.

The flexible connector defines two distinct rings separated by a predefined distance. Each of the two rings receives a carabiner, but another type of anchoring means can be installed therein to meet requirements.

In conventional manner, the connector is formed by a webbing that is folded several times to define two opposite loops in the longitudinal direction of the connector. The multiple thicknesses of webbing are fastened to one another by stitching. Such a teaching is illustrated in the documents USD747176 and US20180001144.

A substantially equivalent teaching is present in the document U.S. Pat. No. 8,973,509 that proposes using a tubular woven material folded around its hollow central part to form a hollow ring. The ring is deformed so as to define two opposite loops separated by an intermediate portion where two thicknesses of the folded woven material are placed in contact and fastened to one another by stitching.

The document US 2015/0352407 proposes another ring configuration where a thread is wound in the form of a coil. The multiple coil turns are enclosed in a strip of textile material that is folded in the longitudinal direction and sewn to form a tube around the coil. The two ends of the tube are fixed to one another to enclose the coil inside a sheath formed by the textile material strip. The tubular woven material no longer defines the mechanical performances of the ring, the latter being mainly defined by the multiple loops that are installed inside the ring.

### SUMMARY OF THE INVENTION

One object of the invention consists in providing a quickdraw connector that presents a better trade-off between compactness, flexibility and tensile strength than the configurations of the prior art.

This result tends to be achieved by means of a quickdraw connector comprising:
a coil of a wire element comprising first turns of said wire element, the coil being divided into a first strand and a second strand arranged consecutively in a longitudinal direction of the wire element;
at least one first tubular element surrounding said first turns to form at least one first sheath around the coil, said at least one first tubular element being passed through by the first turns and extending in a longitudinal direction of the wire element.

The quickdraw connector is remarkable in that an additional tubular element is arranged around the coil to form an additional sheath;
in that the additional tubular element surrounds the assembly formed by the first strand and the second strand arranged adjacent to one another in a direction perpendicular to the longitudinal direction;

in that the coil exits from each of the two opposite ends of the additional tubular element to define a first ring with a first through hole designed to receive a first carabiner and a second ring with a second through hole designed to receive a second carabiner, the second ring being separated from the first ring by the additional tubular element; and in that said at least one first tubular element surrounds the coil continuously along the first ring and the second ring to define a sheath of first ring and a sheath of second ring, each end of the sheath of first ring and of the sheath of second ring being in contact with the additional tubular element.

According to one feature of the invention, the at least one first tubular element partially covers the first turns of the coil in the longitudinal direction of the wire element, a portion of coil not covered by the at least one first tubular element being arranged between the sheath of first ring and the sheath of second ring and covered by the additional tubular element.

In preferential manner, the at least one first tubular element is discontinuous so that the sheath of first ring and the sheath of second ring are separated by a non-covered portion of the coil along the first strand and a non-covered portion along the second strand, the portions of the coil not covered by the at least a first sheath being covered by the additional tubular element.

Advantageously, the at least one first tubular element is fixed to the additional tubular element by stitched seams.

In a particular embodiment, the first strand and second strand are both devoid of covering by the at least one first sheath between the stitched seams along the first strand and second strand.

Preferentially, the at least one first tubular element extends continuously from the first ring to the second ring. The at least one first tubular element has a first tangle pattern forming the sheath of first ring that is different from a second tangle pattern arranged between the coil and the additional tubular element.

In advantageous manner, the first turns of wire element of the coil do not comprise a knot between the two ends of the wire element to form a closed ring.

It is a further object of the invention to provide a quickdraw that presents a better trade-off between compactness, flexibility and tensile strength between the two carabiners than the configurations of the prior art.

This issue tends to be addressed by means of a quickdraw comprising a quickdraw connector according to any one of the foregoing configurations, a first carabiner being installed in the first ring and a second carabiner being installed in the second ring.

It is a further object of the invention to provide a method for manufacturing a quickdraw connector that is simple to implement and that enables a quickdraw connector to be formed that presents a better trade-off between compactness, flexibility and tensile strength than the configurations of the prior art.

This result tends to be achieved by means of a method for manufacturing a quickdraw connector comprising the following steps:
providing a wire element, at least one first tubular element and an additional tubular element;
coiling the wire element to form first turns of said wire element, the wire element passing through a central portion of the at least one first tubular element at each turn so that said at least one first tubular element forms at least one first sheath around the first turns of the wire element;
installing the wire element coil in the additional tubular element, the coil being salient from both ends of the additional tubular element to define a first ring designed to receive a first carabiner and a second ring designed to receive a second carabiner, the second ring being separated from the first ring by the additional tubular element;
   wherein said at least one first tubular element surrounds the first turns from the additional tubular element up to the additional tubular element along the first ring and the second ring.

In advantageous manner, the at least one first tubular element comprises a main first tubular element and a secondary first tubular element distinct from the main first tubular element. During coiling of the wire element to form the first turns, the wire element passes through the main first tubular element and the secondary first tubular element. The main first tubular element covers the first turns along the first ring and the secondary first tubular element covers the first turns along the second ring.

Preferentially, the at least one first tubular element comprises a main first tubular element and a secondary first tubular element connected to the main first tubular element by a sectile portion. After the wire element has been coiled to form the first turns, the main first tubular element is separated from the secondary first tubular element. The main first tubular element covers the first turns along the first ring and the secondary first tubular element covers the first turns along the second ring.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 illustrates a schematic view of the manufacturing steps of a first embodiment of a quickdraw connector where the coil of wire element and the additional tubular element are separated (FIG. 1A), the coil is inserted in the additional tubular element (FIG. 1B), and the sheaths of first ring and second ring extend up to the additional tubular element (FIG. 1C);

FIG. 2 illustrates a schematic view of the manufacturing steps of a second embodiment of a quickdraw connector where the coil of wire element and the additional tubular element are separated (FIG. 2A), and the sheaths of first ring and second ring extend up to the additional tubular element (FIG. 2B);

FIG. 3 illustrates a schematic view of the manufacturing steps of a third embodiment of a quickdraw connector where the coil of wire element and the additional tubular element are separated (FIG. 3A), and the sheaths of first ring and second ring extend up to the additional tubular element (FIG. 3B);

FIG. 4 illustrates a schematic view of the manufacturing steps of a fourth embodiment of a quickdraw connector where the coil of wire element and the additional tubular element are separated (FIG. 4A), and the sheaths of first ring and of second ring extend up to the additional tubular element (FIG. 4B);

FIG. 5 illustrates a schematic view of the manufacturing steps of a fifth embodiment of a quickdraw connector where the coil of wire element and the additional tubular element are separated (FIG. 5A), and the sheaths of first ring and second ring extend up to the additional tubular element (FIG. 5B);

FIG. 6 illustrates a schematic view of a quickdraw with two carabiners and a quickdraw connector;

FIG. 7 illustrates a schematic view of the manufacturing steps of a sixth embodiment of a quickdraw connector where the coil of wire element and the additional tubular element are separated (FIG. 7A) the sheath of first ring extends up to the additional tubular element (FIG. 7B) and the sheath of second ring extends up to the additional tubular element (FIG. 7C).

### DETAILED DESCRIPTION

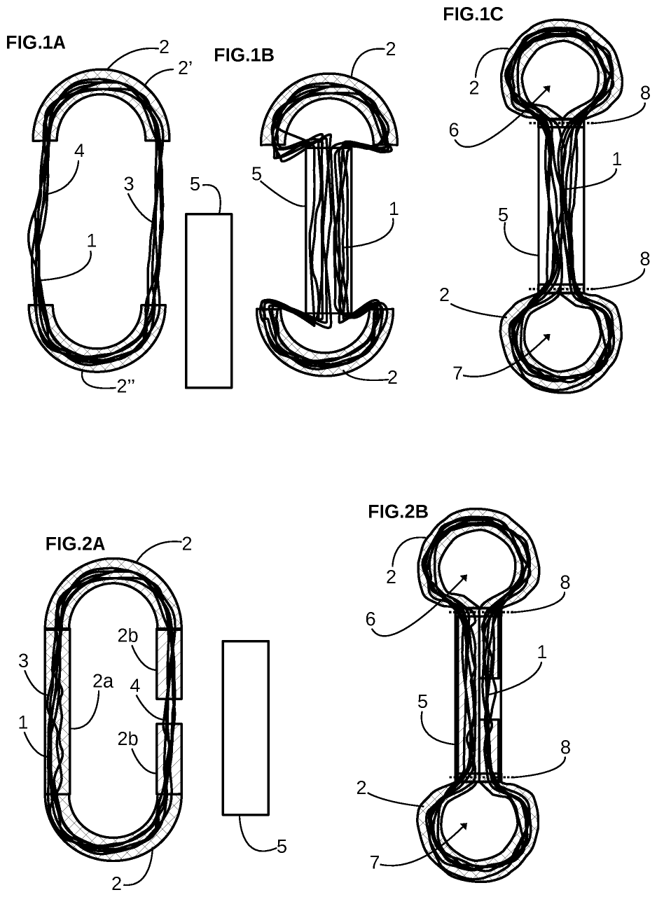

FIGS. 1 to 5 and 7 illustrate different embodiments of a quickdraw connector. The quickdraw connector has a wire element 1 that is coiled to define a coil having first turns of the wire element 1. The turns of the wire element 1 are in the form of loops that are arranged on one another to define a ring. For example, the coil comprises at least 10 turns or at least 20 turns. The wire element 1 can be a rope, a webbing, a braid, a continuous fibre or any other suitable thread or fibre. For example, the wire element 1 is a wire element made from Dyneema®.

The wire element 1 extends continuously to define the multiple loops. The coil formed by the multiple loops can be divided into a first strand and a second strand. For example, the coil is divided into two halves, each half representing a strand of the coil. Depending on the embodiments, the first strand and second strand comprise the same number of wire elements or a difference that represents one turn of the wire element. The first strand 3 and the second strand 4 are arranged consecutively in a longitudinal direction of the wire element 1.

The quickdraw connector has at least one first tubular element 2 that only surrounds said first turns. The at least one first tubular element 2 extends in the longitudinal direction of the wire element 1 to form at least one first sheath around the first turns of the wire element 1. In other words, the at least one first tubular element 2 follows the shape of the ring or of a part of the ring. Depending on the embodiments, the at least one first sheath covers the whole of the coil or only a part of the coil in the longitudinal direction of the wire element 1.

The at least one first sheath comprises the first turns once only, i.e. the first sheath follows the shape of the coil and or the part of the coil it covers. The at least one first sheath is not arranged to receive both the first strand 3 and the second strand 4 arranged adjacent to one another perpendicularly to the longitudinal direction of the wire element 1, i.e. a volume corresponding to a doubling-up of the wire elements 1.

The at least one first tubular element 2 is designed to form a sheath around the multiple loops of the wire element 1 taken together as a set. The at least one first tubular element 2 protects the wire element 1 from external aggression.

What is meant by tubular element 2 is preferentially an element that is intrinsically tubular, i.e. without any bonding, stitching, welding or other operation. The at least one first tubular element 2 is preferentially chosen from a tubular webbing, i.e. a tubular woven element, or it can be a tubular braid or a tubular knitted element. The use of an intrinsically tubular element enables a better trade-off to be achieved between compactness and flexibility.

It is particularly advantageous for the inner volume of the at least one first tubular element 2 to be mainly filled by the multiple turns of the wire element. Preferentially, the volume occupied by the wire element 1 represents at least 50% of the inner volume of the at least one first tubular element 2, more preferentially at least 70% and even more preferentially at least 80%. The larger the volume occupied by the wire element 1 inside the at least one first tubular element 2, the more the different loops of the wire element 1 are forced to rub against one another, thereby enabling the mechanical resistance of the ring formed by the loops of the wire element 1 to be fixed when a tensile stress is applied. The tensile strength is provided by the turns of the wire element 1 and not by the at least one first tubular element 2.

In addition to the at least one first tubular element 2, the quickdraw connector comprises an additional tubular element 5 that forms an additional sheath. The additional tubular element 5 is preferentially an intrinsically tubular element, i.e. without a stitching, welding, bonding or other step. It is preferable for the additional tubular element 5 to be chosen from a tubular webbing, i.e. a tubular woven element, or it can be a tubular braid. It is also possible to provide for the additional tubular element 5 to be a tubular knitted element. The choice of the additional tubular element 5 is independent from the at least one first tubular element 2.

The two strands of the coil pass through the additional tubular element 5. The additional tubular element 5 surrounds the assembly formed by the first strand 3 and the second strand 4 arranged adjacent to each other in a direction perpendicular to the longitudinal direction. The coil is salient from both ends of the additional tubular element 5 so that the coil of the wire element 1 associated with the additional tubular element 5 together define a first ring 6 and a second ring 7. The two rings are separated by the additional tubular element 5. The first ring 6 defines a first through hole designed to receive a first carabiner and the second ring 7 defines a second through hole designed to receive a second carabiner. The two carabiners are separated by the additional tubular element 5.

The at least one first tubular element 2 surrounds the coil of the wire element 1 along the first ring 6 and along the second ring 7 outside the area covered by the additional sheath. The at least one first sheath extends continuously along the first ring 6 to form a sheath of first ring and extends continuously along the second ring 7 to form a sheath of second ring. Both of the ends of the sheath of first ring and of the sheath of second ring are in contact with the additional sheath to protect the coil.

It is particularly advantageous to secure the ends of the sheath of first ring to one end of the additional tubular element 5 by a fastening 8. The fastening 8 is preferentially a stitched seam. It is particularly advantageous to secure the ends of the sheath of second ring to the other end of the additional tubular element 5.

It is advantageous for the additional tubular element 5 to be fixed only to the at least one first tubular element 2 at the ends that define the sheath of first ring and the sheath of second ring, thereby obtaining a greater mobility of the turns of the coil of the wire element 1 in the overlap area that may exist between the additional tubular element 5 and the at least one first tubular element 2. This results in a gain in flexibility.

To gain in flexibility and/or in compactness, it is particularly advantageous for the at least one first tubular element 2 not to cover the whole of the coil in the longitudinal direction. It is then possible to define an area of the coil that is covered by the at least one first tubular element 2 and an area that is not covered by the at least one first tubular element 2, i.e. an area that is directly facing the additional tubular element 5. The portion of the coiling not covered by the first tubular element 2 is covered by the additional tubular element 5,

FIG. 2A illustrates an embodiment where the at least one first tubular element 2 extends continuously along the coil so as to cover the whole of the length of the coil or almost all of the coil. Inside the inner volume of the additional tubular element 5, the first strand 3 and the second strand 4 of the coil are to be found, along with a portion of the at least one first tubular element 2 that surrounds the coil around the first strand 3 and the second strand 4. It is then necessary to choose an additional tubular element 5 of large diameter to accommodate all these items, as illustrated in FIG. 2B. The larger the diameter, the greater the size of the quickdraw connector. The smaller the diameter, the more the turns of the wire element 1 are jammed, thereby limiting the flexibility and making manufacture of the quickdraw connector more complicated.

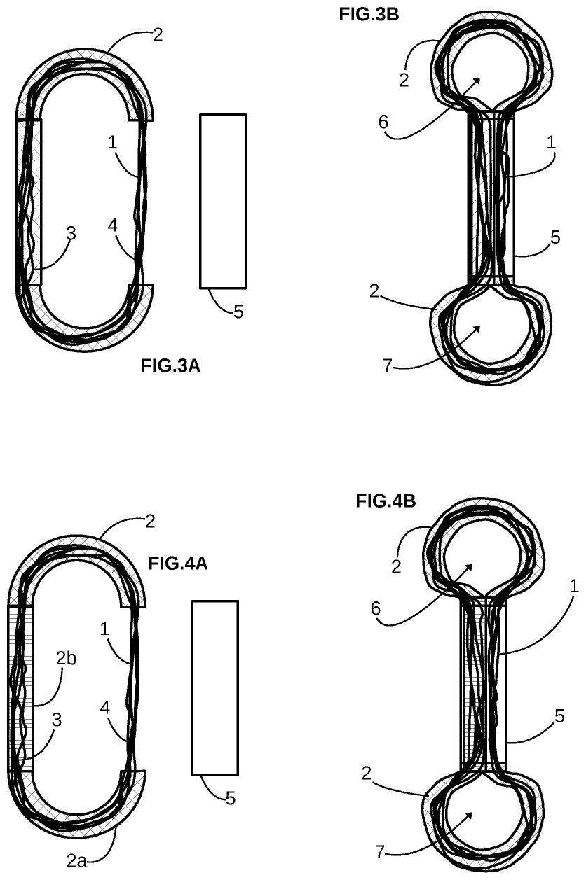

FIGS. 3A and 4A illustrate an embodiment where the at least one first tubular element 2 extends only partially along the coil so as to cover the whole of the length of the coil of the first strand 3 and of each of the portions of the coil salient from the additional tubular element 5 designed to form the first ring 6 and the second ring 7. The rest of the second strand 4 is not covered. Inside the inner volume of the additional tubular element 5, the first strand 3 and the second strand 4 of the coil are to be found, along with the part 2a of the at least one first tubular element 2 that covers the first strand 3 and the ends of the sheath of first ring and of the sheath of second ring. It is then possible to choose an additional tubular element 5 of smaller dimension to receive all these elements, due to the fact that a part of the first tubular element 2 has been eliminated in comparison with the previous embodiment. Advantageously, there is only one first tubular element 2 that extends continuously to form the sheath of first ring and the sheath of second ring.

FIG. 1A, illustrates an embodiment where the at least one first tubular element 2 covers the first turns of the wire element 1 along the first ring 6 to form the sheath of first ring and covers the first turns of the wire element 1 along the second ring 7 to form the sheath of second ring. The two portions designed to form the sheath of first ring and the sheath of second ring are distinct and spaced apart from one another. The first tubular element 2 has two distinct parts with a main first tubular element 2′ and a secondary first tubular element 2″ distinct from the main first tubular element 2′. The main first tubular element 2′ is separated from the secondary first tubular element 2″ by two non-covered areas that extend respectively along the first strand 3 and the second strand 4. Between the first ring 6 and the second ring 7, the coil is devoid of the first tubular element 2 continuously covering the first strand 3 and continuously covering the second strand 4.

It is particularly advantageous for the main first tubular element 2′ and the secondary first tubular element 2″ to extend up to fastenings 8 that secure the first tubular element 2 with the additional tubular element 5. It is advantageous for the first tubular element 2 not to extend beyond the fastenings 8 in the direction connecting the main first tubular element 2′ and the secondary first tubular element 2″. What is meant by not to extend beyond the fastenings 8 is that the first tubular element 2 does not extend too far beyond the fastenings 8. The first tubular element 2 extends sufficiently far beyond the fastenings 8 to avoid damaging the fastening 8. The same is advantageously the case for the additional tubular element 5 in the opposite direction.

Inside the inner volume of the additional tubular element 5, the first strand 3 and the second strand 4 of the coil are to be found, along with the ends of the sheath of first ring and of the sheath of second ring. As the coil is almost devoid of the first tubular element 2 under the additional tubular element 5, it is then possible to choose an additional tubular element 5 of less large diameter to receive all these elements. The less deeply the first tubular element 2 extends inside the additional tubular element 5 along the first strand 3 and along the second strand 4, the more possible it is to choose an additional tubular element 5 of small diameter. Reducing the diameter of the additional tubular element 5 improves the compactness of the latter, and the absence of the first tubular element 2 enables a greater freedom of movement of the turns of the wire element 1 to be had, thereby enhancing the flexibility.

It is particularly advantageous for the turns of the wire element 1 to represent at least 50% of the inner volume of the additional tubular element 5, more preferentially at least 70% or even at least 80%.

In an alternative embodiment or as a complement and as illustrated in FIG. 4A, it is sought to have a single first tubular element 2 extending along the first strand 3 and along the second strand 4 and inside the additional tubular element 5. To be able to reduce the diameter of the additional tubular element 5, the at least one first tubular element 2 presents a smaller volume per length of coil in comparison with that illustrated in FIG. 2. It is advantageous to have a first tubular element 2 which has a first portion with a smaller volume than a second portion defining the sheath of first ring and a third portion defining the sheath of second ring. The first portion is arranged between the coiling and the additional tubular element 5. The volume is measured for a given length of portion. In an alternative embodiment, the first tubular element 2 has a first portion with greater compression than a second portion defining the sheath of first ring and a third portion defining the sheath of second ring. The first portion is arranged between the coiling and the additional tubular element 5. Compression is measured in response to a given force.

It is advantageous to provide for the first tubular element 2 to present a tangle pattern between the threads and/or fibres that form the additional tubular element 5 that is variable in the longitudinal direction of the additional tubular element 5 corresponding to the longitudinal direction of the coil. The first tubular element 2 presents a first tangle pattern that is different from a second tangle pattern. The first tangle pattern is designed to form the sheath of first ring and/or the sheath of second ring. The second tangle pattern is designed to be located inside the additional tubular element 5. The second tangle pattern presents a smaller volume than the first tangle pattern for a given length. The space occupation corresponds to a volume of threads or fibres used per given length of the first tubular element 2. A differentiation of the tangle pattern can be a differentiation of the weaving pattern, a differentiation of the braiding pattern, a differentiation of the knitting pattern, or a modification of the number of threads used or of the cross-section of the threads used.

For example, it is advantageous to preserve a mechanical link between the portion of the first tubular element 2 designed to form the sheath of first ring and the portion of the first tubular element 2 designed to form the sheath of second ring in order to better control the positions of the different portions of the first tubular element 2 when manufacturing the quickdraw connector. Preferably and as illustrated in the various figures, the first tubular element 2 extends continuously from the first ring to the second ring to facilitate positioning of the sheath of first ring and the sheath of second ring during manufacture prior to fastening.

FIG. 4 illustrates an embodiment where the first tubular element 2 has a first portion 2a that has a first tangle pattern and a second portion 2b that has a second tangle pattern. The first portion 2a with the first tangle pattern is designed to form the sheath of first ring and/or the sheath of second ring. The second portion 2b with the second tangle pattern is designed to be situated inside the additional tubular element 5.

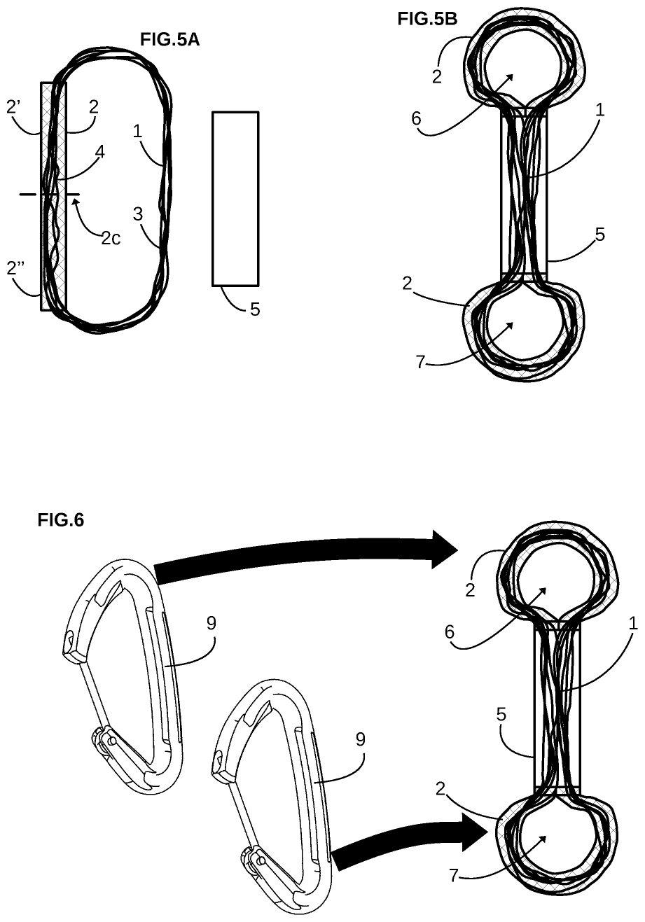

In the embodiment illustrated in FIG. 5, the first tubular element 2 has a portion designed to form the sheath of first ring, a portion designed to form the sheath of second ring and an additional portion designed to form the mechanical link between the sheath of first ring and the sheath of second ring. The additional portion can define a sectile link that yields easily during manufacture of the quickdraw connector. This makes it possible to have a single first tubular element 2 that separates into two. This single tubular element is preferable when performing a coiling step where the wire element 1 passes through the centre of the first tubular element 2 to form the coil. Once the coil has been formed, the two parts of the first tubular element 2 can be dissociated. The sectile portion can be formed by a tangle pattern different from the tangle patterns designed to form the sheath of first ring and the sheath of second ring, or it can be the same tangle pattern that is weakened by an additional technological operation, for example laser or manual cutting, application of an acid, a base or a solvent, or application of an electromagnetic radiation. Separation of the sheath of first ring and the sheath of second ring can be achieved by pulling, as the sectile portion yields preferentially to the sheath of first ring and the sheath of second ring. For example, separation of the sheath of first ring and sheath of second ring can take place after securing the first tubular element 2 with a first end of the additional tubular element 5 to form the sheath of first ring and before securing the first tubular element 2 with the second end of the additional tubular element 5 to form the sheath of second ring. After separation, the sheath of first ring and the sheath of second ring have two complementary cutting edges. The cutting edges preferably belong to an entanglement pattern that is different from the entanglement pattern that defines the sheath of first ring and the sheath of second ring. Preferably, the entanglement pattern defining the sectile zone has a smaller volume than the entanglement pattern defining the sheath of first ring and the sheath of second ring for a given length and/or exhibits greater compression in response to a given force. The length is measured in the longitudinal direction of the wire element. The force is applied perpendicular to the longitudinal direction of the wire element.

The length of the coil is measured in the longitudinal direction of the wire element 1. If the coil is in the form of a circle, the length of the coil corresponds to the perimeter of the circle.

Each end of the at least one first tubular element 2 preferably has a portion covered by the additional tubular element 5 to avoid having a bare wire element 1.

As the wire element 1 extends continuously from one end of the quickdraw connector to the other defining the first ring 6 and the second ring 7, it thus provides the mechanical continuity between the two rings when the quickdraw connector is subjected to a tensile stress. The mechanical continuity provided by the coil of the wire element 1 comprises several turns that are movable with respect to one another, thereby making it easier to obtain a quickdraw connector presenting a better trade-off between weight, flexibility and compactness.

The at least one first tubular element 2 and the additional tubular element 5 surround the coil of the wire element 1 thereby limiting the movements of the different turns with respect to one another. This enables the coil of the wire element 1 to provide the required mechanical performances in traction while allowing a good flexibility in the other directions. Advantageously, the additional tubular element 5 is at least 30% filled. Filling is observed along a cutting plane that is perpendicular to the longitudinal direction of the first strand 3 and to the longitudinal direction of the second strand 4. The turns of the wire element 1 may represent at least 30% of the first tubular element 2 in the sheath of first ring, in the sheath of second ring and more preferentially in each position of the first tubular element 2.

This embodiment is particularly advantageous in comparison with a webbing as it enables a better trade-off to be had between tensile strength in the longitudinal direction and flexibility in the other directions for a given compactness.

The quickdraw connector can be manufactured in the following manner. The method for manufacturing a quickdraw connector comprises a step of providing a wire element 1, at least one first tubular element 2 and an additional tubular element 5. The wire element 1 is then coiled to form first turns of said wire element 1. The wire element 1 passes through a central portion of the at least one first tubular element 2 at each turn so that the at least one first tubular element 2 forms at least a first sheath around the first turns of the wire element 1. The first turns of the wire element 1, i.e. the coiling, are installed in the additional tubular element 5. The additional tubular element 5 partially covers the coil to define a first ring 6 designed to receive a first carabiner and a second ring 7 designed to receive a second carabiner. The second ring 7 is separated from the first ring 6 by the additional tubular element 5. It is particularly advantageous for the at least a first sheath to surround the first turns from the additional tubular element 5 up to the additional tubular element 5 along the first ring 6 and the second ring 7.

In preferential manner, the at least one first tubular element 2 comprises a main first tubular element 2′ and a secondary first tubular element 2″ distinct from the main first tubular element 2′. During coiling of the wire element 1 to form the first turns, said wire element 1 passes through the main first tubular element 2′ and the secondary first tubular element 2″. The main first tubular element 2′ covers the first turns along the first ring 6 and the secondary first tubular element 2″ covers the first turns along the second ring 7.

Preferably, the first tubular element 2 is attached to a first end of the additional tubular element 5 and to a second end of the additional tubular element 5. The first tubular element 2 surrounds the first turns from the additional tubular element 5 to the additional tubular element 5 along the first ring 6 to form a sheath of first ring and along the second ring 7 to form a sheath of second ring.

In the embodiment illustrated in FIGS. 2, 3 and 4, the first tubular element 2 extends continuously from the first ring 6 to the second ring 7 before securing the first tubular element to both ends of the additional tubular element 5. In the embodiment shown in FIG. 4, after securing the first tubular element 2 to both ends of the additional tubular element 5, the first tubular element 2 extends continuously from the first ring 6 to the second ring 7. The first tubular element 2 has a first entanglement pattern forming the sheath of first ring which is different from a second entanglement pattern arranged between the coiling and the additional tubular element 5.

Advantageously, as illustrated in FIG. 5A, the at least one first tubular element 2 comprises a main first tubular element 2′ and a secondary first tubular element 2″ connected to the main first tubular element 2′ by a sectile portion 2c. After the wire element 1 has been coiled to form the first turns, the main first tubular element 2′ is separated from the secondary first tubular element 2″. The main first tubular element 2′ covers the first turns along the first ring 6 and the secondary first tubular element 2″ covers the first turns along the second ring 7. It is advantageous for the first tubular element 2 to be longer than the additional tubular element 5 in order to facilitate gripping of each of the two ends of the first tubular element 2 to apply a tensile force that causes the sectile portion 2c to yield.

In a particular embodiment shown in FIG. 7, the first tubular element 2 is long enough to form the sheath of first ring and protrude from the second end of the additional tubular element 5 (FIG. 7B). This makes it possible to install the first tubular element 2 so as to effectively form the sheath of first ring and then secure one or both ends of the sheath of first ring with the additional tubular element 5. Once secured, the sectile portion can be yielded so that the first secondary tubular element 2′ is moved to form the sheath of second ring, and then both ends of the sheath of second ring are preferably secured to the additional tubular element 5 (FIG. 7C).

FIG. 1B illustrates a manufacturing step where the first tubular element 2 is arranged beyond the additional tubular element 5 to prepare formation of the sheath of first ring and the sheath of second ring. This embodiment is not advantageous as it is preferable to install the ends of first tubular elements 2 in the additional tubular element 5. It is particularly advantageous to hold the ends of at least one of the sheaths of first ring and of second ring in the additional sheath and to secure the fastening 8 before finalising formation of the other of the sheath of first ring and the sheath of second ring.

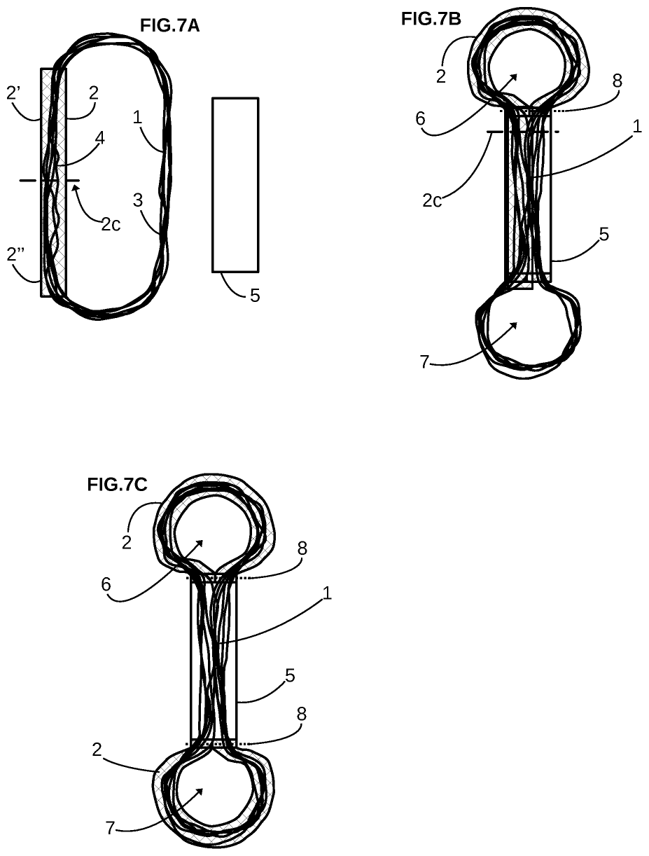

As illustrated in FIG. 6, a quickdraw is formed by installing one carabiner 9 in the first ring 6 and another carabiner 9 in the second ring 7.

1. Quickdraw connector comprising:
a coil of a wire element comprising first turns of said wire element, the coil being divided into a first strand and a second strand arranged consecutively in a longitudinal direction of the wire element;
at least one first tubular element surrounding said first turns to form at least one first sheath around the coil, said at least one first tubular element being passed through by the first turns and extending in a longitudinal direction of the wire element;
an additional tubular element arranged around the coil to form an additional sheath, the additional tubular element surrounding an assembly formed by the first strand and the second strand arranged adjacent to one another in a direction perpendicular to the longitudinal direction;
wherein the coil is salient from each of two opposite ends of the additional tubular element to define a first ring with a first through hole designed to receive a first carabiner and a second ring with a second through hole designed to receive a second carabiner, the second ring being separated from the first ring by the additional tubular element; and
wherein said at least one first tubular element continuously surrounds the coil along the first ring and the second ring to define a sheath of first ring and a sheath of second ring, each end of the sheath of first ring and of the sheath of second ring being in contact with the additional tubular element;
wherein said at least one first tubular element extends continuously from the first ring to the second ring or in that the sheath of first ring and the sheath of second ring are separated by a non-covered portion of the coil not covered by said at least one first tubular element along the first strand and a non-covered portion not covered by said at least one first tubular element along the second strand, the non-covered portions not covered by said at least one first tubular element being covered by the additional tubular element, the sheath of first ring having a cutting front that is complementary to a cutting front of the sheath of second ring, the cutting fronts belonging to a second entanglement pattern of the at least one first tubular element that is different from a first entanglement pattern of said at least one first tubular element forming the sheath of first ring.

2. Quickdraw connector according to claim 1 wherein said at least one first tubular element extends continuously from the first ring to the second ring.

3. Quickdraw connector according to claim 2 wherein said at least one first tubular element has a first part having a smaller volume than a second portion defining the sheath of first ring and than a third portion defining the sheath of second ring, the first portion being disposed between the coiling and the additional tubular element, the volume being measured for a given length of portion.

4. Quickdraw connector according to claim 2 wherein said at least one first tubular element has a first part having a compression greater than a second portion defining the sheath of first ring and than a third portion defining the sheath of second ring, the first portion being disposed between the coiling and the additional tubular element (5), the compression being measured in response to a given effort.

5. Quickdraw connector according to claim 2 wherein said at least one first tubular element has a first entanglement pattern forming the sheath of first ring that is different from a second entanglement pattern disposed between the coiling and the additional tubular element.

6. Quickdraw connector according to claim 1 wherein the sheath of first ring and the sheath of second ring are separated by the portion not covered by said at least one first tubular element along the first strand and the portion not covered by said at least one first tubular element along the second strand.

7. Quickdraw connector according to claim 1 wherein the second entanglement pattern has a smaller volume than the first entanglement pattern for a given length and/or the second entanglement pattern has a greater compression than the first entanglement pattern in response to a given effort.

8. Quickdraw comprising a quickdraw connector according to claim 1 and comprising a first carabiner installed in the first ring and a second carabiner installed in the second ring.

9. Quickdraw connector according to claim 1 wherein the at least one first tubular element is fixed to the additional tubular element by stitched seams.

10. Quickdraw comprising a quickdraw connector according to claim 1 and comprising a first carabiner installed in the first ring and a second carabiner installed in the second ring

11. Method for manufacturing a quickdraw connector comprising the following steps:
providing a wire element, a first tubular element and an additional tubular element;
coiling the wire element to form first turns of said wire element, the wire element passing through a central portion of the first tubular element at each turn so that the first tubular element forms at least a first sheath around the first turns of the wire element;
installing the coil of the wire element in the additional tubular element, the coil being salient from both ends of the additional tubular element to define a first ring designed to receive a first carabiner and a second ring designed to receive a second carabiner, the second ring being separated from the first ring by the additional tubular element;
securing the first tubular element to a first end of the additional tubular element and to a second end of the additional tubular element, the first tubular element surrounding the first turns from the additional tubular element up to the additional tubular element along the first ring to form a sheath of first ring and along the second ring to form a sheath of second ring;
wherein the first tubular element extends continuously from the first ring to the second ring before securing the first tubular element to the first and second ends of the additional tubular element.

12. Method for manufacturing a quickdraw connector according to claim 11 wherein after securing the first tubular element to the first and second ends of the additional tubular element, the first tubular element extends continuously from the first ring to the second ring and wherein the first tubular element has a first entanglement pattern forming the sheath of first ring which is different from a second entanglement pattern disposed between the coil and the additional tubular element.

13. Method for manufacturing a quickdraw connector according to claim 11 wherein the first tubular element comprises a first main tubular element and a first secondary tubular element connected to the first main tubular element by a sctile portion, wherein after coiling the wire element to form the first turns and before fixing the first tubular element to the first and second ends of the additional tubular element, the first main tubular element is separated from the first secondary tubular element and wherein the first main tubular element covers the first turns along the first ring and the first secondary tubular element covers the first turns along the second ring.

14. Method for manufacturing a quickdraw connector according to claim 13 wherein the first main tubular element is separated from the first secondary tubular element after securing the first tubular element with the first end of the additional tubular element and before securing the first tubular element with the second end of the additional tubular element.

15. Method for manufacturing a quickdraw connector according to claim 13 wherein the first main tubular element is separated from the first secondary tubular element by pulling on the sectile portion
